(19) United States
(12) Patent Application Publication
(10) Pub. No.: US 2015/0220944 A1
(43) Pub. Date: Aug. 6, 2015

(54) OBTAINING REAL ESTATE SALES LEADS

(71) Applicant: Landvoice Data, LLC, American Fork, UT (US)

(72) Inventors: Jacob L. Fackrell, Highland, UT (US); Shaun V. Farr, Provo, UT (US); Jack R. Sevison, Provo, UT (US)

(21) Appl. No.: 14/686,399

(22) Filed: Apr. 14, 2015

Related U.S. Application Data
(63) Continuation of application No. 13/928,199, filed on Jun. 26, 2013.

(51) Int. Cl. G06Q 30/02; G06Q 50/16

(52) U.S. Cl. CPC G06Q 30/0201; G06Q 50/16

(57) ABSTRACT

A method for generating sales leads may include mapping data fields between a remote real estate listings database and a local listing database, and providing a database adapter to migrate listings from the remote database to the local database according to the data field mapping, querying a listing database for listings within a selected time interval and geographical region, receiving a base set of listings, executing filters that remove listings for property currently for sale or that have changed ownership since the original listing date from the base set of listings, and adding the base set of listings into the local listing database. A system and apparatus corresponding to the above methods are also disclosed herein.

### BACKGROUND OF THE INVENTION

1. Field of the Invention

The claimed invention relates to sales lead generation in general, and apparatus, systems, means, and methods for real estate sales lead generation in particular.

2. Description of the Related Art

In most markets, real estate sales is a highly competitive environment, with many agents competing to represent relatively few sellers. Agents often have to resort to cold calling—making unsolicited calls to potential sellers about whom little is known. Agents may have to make hundreds of cold calls to obtain one listing for sale.

### BRIEF SUMMARY OF THE INVENTION

The present invention has been developed in response to the present state of the art, and in particular, in response to the technical problems and needs in the art that have not yet been fully solved by currently available real estate sales lead generation systems, apparatus, and methods. Accordingly, the claimed inventions have been developed to provide a real estate sales lead generation apparatus, method, and system that overcome shortcomings in the art.

As detailed herein, a method for generating sales leads may include may include mapping data fields between a remote real estate listings database and a local listing database, and providing a database adapter to migrate listings from the remote database to a local database according to the data field mapping. The method may also include querying the remote real estate listings database for listings within a selected time interval and geographical region, receiving a base set of listings, executing filters that remove listings currently for sale or that have changed ownership since the original listing date from the base set of listings, and obtaining contact information for listings remaining in the base set to create sales leads.

Apparatus corresponding to the above methods are also disclosed herein. Furthermore, various elements of the present invention are combined into a system for generating sales leads.

It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one example of a sales lead generation system that is consistent with one or more embodiments of the claimed invention;

FIG. 2 is a block diagram of one example of a sales lead generation apparatus that is consistent with one or more embodiments of the claimed invention;

FIG. 3 is a flowchart diagram of one example of a sales lead generation method that is consistent with one or more embodiments of the claimed invention;

FIG. 4 is a flowchart diagram of one example of a sales lead selection method that is consistent with one or more embodiments of the claimed invention;

FIG. 5 is a graphical and textual depiction of one example of a sales lead selection user interface that is consistent with one or more embodiments of the claimed invention; and

FIG. 6 is a flowchart diagram of one example of a sales data migration method that is consistent with one or more embodiments of the claimed invention.

### DETAILED DESCRIPTION OF THE INVENTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein the term “listing”, absent of other qualifying language, refers to any current or former posting to a real estate database or the like. As such, a listing may be a current (i.e. active) listing, a recently expired listing, or an old expired listing.

A higher listing success rate can be obtained by filtering the pool of prospective sellers to be contacted by criteria that correspond to prospects that are more likely to want to sell. For example, homes are typically listed for sale for six months. When a listing expires with the property unsold, the seller may be interested in relisting the property with a different agent.

Sudden, significant shifts in market conditions may result in many real estate listings expiring unsold, with sellers left in a market where sales are unlikely in the near future. Sellers may also find that changing economic conditions have left them in a situation where their reasons for wanting to sell their property no longer apply. Expectations of future income may have been revised downward, so sellers may delay moving to more expensive homes. Changes in a job market may coincide with changes in the real estate market, so relocation plans may have to be postponed.

In time, market conditions may reverse, and, as the Applicants have observed, the reasons that originally motivated property owners to list their homes for sale may arise again. Consequently, the Applicants assert that many old expired, canceled, or withdrawn listings may become a productive source of potential clients for a realtor. Furthermore, technical issues may prohibit the direct use of real estate listings within a database.

Accordingly, the apparatuses, systems and methods disclosed herein provide real estate sales lead generation that select potential sellers according to criteria that consider the effects of market changes.

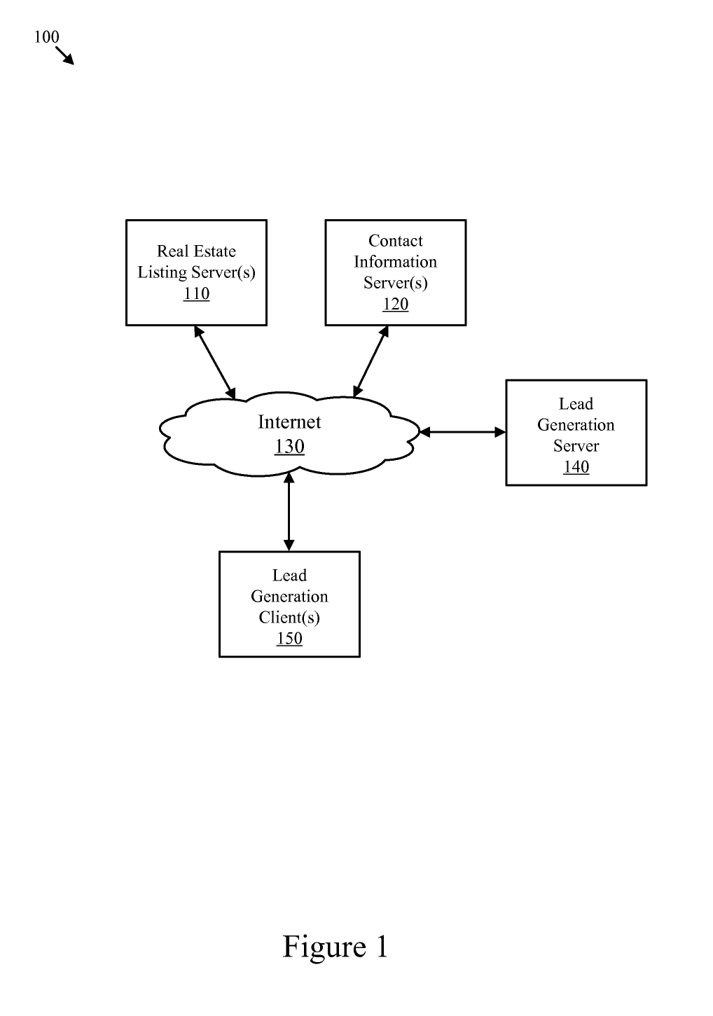

FIG. 1 is a block diagram of one example of a sales lead generation system 100 that is consistent with one or more embodiments of the claimed invention. As depicted, the sales lead generation system 100 includes a variety of modules including modules residing on one or more real estate listing servers 110, one or more contact information servers 120, a lead generation server 140, and one or more lead generation clients 150. Each of the modules may reside on a single computing device (i.e. node) or be collaboratively partitioned onto multiple devices or nodes. The modules may be primarily or wholly comprised of software codes and associated data that are executed and processed by a digital processing apparatus such as a computer to provide the specified functionality. The modules may be interconnected with a local network or an inter-network such as the depicted Internet 130.

The real estate listing servers 110 may store and provide current and expired listings (collected over a period of time) corresponding to one or more geographical regions. Property listings stored on the real estate listing server 110 may contain data describing a property for sale and may be searchable by listing date, geographical region, sale date, foreclosure status, short sale status, and the like. In one embodiment, a real estate listing server 110 may be a community Multiple Listing Service database complying with the Real Estate Transaction Standard database format. In other embodiments, a real estate listing server 110 may be a listing database proprietary to a realty firm and in a proprietary database format.

The contact information servers 120 provide contact information for individuals such as property owners associated with real estate listings. In some embodiments, the contact information servers 120 may be commercial services providing contact information, such as phone numbers or cell phone numbers associated with a property address or property owner name. Although FIG. 1 depicts contact information servers 120 as electronically connected to the Internet, in some embodiments, contact information servers 120 may also be paper-based files of property tax or property title records. In such embodiments, files may be searched manually and contact information provided by entering property owner names, addresses, phone numbers, or the like into database records associated with property listings.

The sales lead generation system 100 depicted in FIG. 1 includes the Internet 130. While typical embodiments may include the Internet, other embodiments may rely, in whole or in part, on other networks such as local area networks. For example, a contact information server 120 may reside on a local area network with one or more lead generation clients 150, and access a real estate listing server 110 via the Internet.

The lead generation server 140 receives requests for sales leads from lead generation clients 150 and queries real estate listing servers 110 and contact information servers 120 to obtain data records that may be combined to form sales leads to be provided to the clients 150. Listing servers 110 and contact information servers 120 may require authentication before servicing queries. In one embodiment, the lead generation server 140 receives authentication credentials from the client 150 and transmits them to either or both of the servers 110 and 120 for authentication. In another embodiment, credentials for either or both of the servers 110 and 120 are stored on the lead generation server 140.

The lead generation server 140 may employ a different database schema than the servers it queries, and therefore necessarily convert or transform the data from the source database schema to the schema of the lead generation server 140. While one embodiment of the lead generation server 140 includes data conversion or transformation intrinsic to the server, one of skill in the art will appreciate the advantages provided by separating data conversion or transformation operations into a data field mapping specification and database adapter, separate from the other functions of the lead generation server 140. If the real estate listing server 110 and the lead generation server 140 use the same database management system, such as SQL, migrating data from the listing server 110 may be possible using properly structured queries. The data conversion and transformation service may also employ data transformation languages and tools, such as AWK, Perl, TXL, XSLT, or the like, or in some embodiments be implemented as custom-developed code.

The lead generation server 140 may receive and service database queries from database client workstations directly, or in some embodiments the lead generation server 140 may include a web server that provides a form, web-based application, or the like that a client may use to submit data fields on which database queries may be based. In such embodiments, the web server constructs and submits database queries, receives responses to the queries, formats data received from the database queries for display to the client, and transmits the formatted data to the requesting client browser or application. In various embodiments, the database and web server portions of a lead generation server 140 may operate on a single server or the provided services divided among multiple servers.

The lead generation clients 150 submit sales lead queries to the lead generation server 140 and receive sales lead data for display to the requesting user. Lead generation clients may accept input from a user indicating the listing server 110 to be queried and receive authentication credentials for the listing server 110. Lead generation clients 150 may also accept input from a user indicating a time period and geographical region in which to search for expired real estate listings. Lead generation clients may also display sale leads received from a lead generation server 140 and allow the user to select sales leads for which additional data fields are to be displayed, or the owner contacted.

In one embodiment, the lead generation client 150 is a database front end that displays one or more forms in which a user may enter data to be used to query the lead generation server 140 database and to display sales leads received in response to the queries. In another embodiment, lead generation clients 150 may be a computer running a web browser that receives a form or web application from a lead generation server 140 web server in which a user may enter data to be used to query the server 140 database and display sales leads received in response to the queries. In such embodiments, sales leads may be received as web pages in HTML format, or as data to be displayed in an application running in a browser.

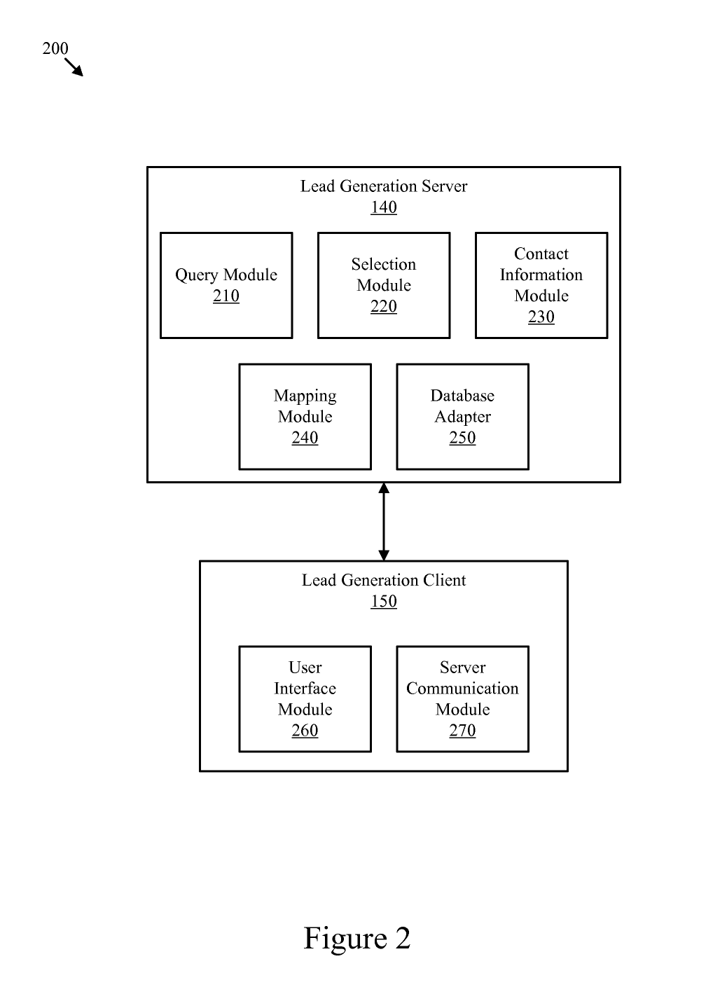

FIG. 2 is a block diagram of one example of a sales lead generation apparatus 200 that is consistent with one or more embodiments of the claimed invention. The sales lead generation apparatus 200 may include a query module 210, selection module 220, contact information module 230, mapping module 240, a database adapter 250, a user interface module 260 and a server communication module 270. In the depicted embodiment, the various modules of the sales lead generation apparatus 200 are partitioned onto the lead generation server 140 and one or more lead generation clients 150 depicted in FIG. 1. The sales lead generation apparatus 200 facilitates searching, generating, and displaying real estate sales leads.

The query module 210 queries real estate listing databases using query parameters from the lead generation client 150. In one embodiment, the query module 210 receives query parameters from the lead generation client 150, submits queries to the real estate listing server 110, and receives responses to the submitted queries. In another embodiment, the query module 210 queries a listing database local to the lead generation server 140 containing listings previously obtained by querying a real estate listing server 110.

Query parameters may include a URL and authentication credentials for the real estate listing server 110, beginning and ending dates for the time period to be searched, and a specification such as a Zip Code for the geographical region to be searched. Alternatively, the query module 210 may obtain a network location and authentication credentials for the real estate listing server 110 from a data store on the lead generation server 140. In response to a submitted query, the query module 210 receives a base set of real estate listings to be filtered by the selection module 220.

The selection module 220 may execute one or more filters to remove listings that meet specified criteria from the base set of listings received by the query module 210. For example, filters executed by the selection module 200 may remove listings of properties currently listed for sale, that have sold since the listing date, that have been foreclosed since the listing date, or that have been part of a short sale since the listing date.

The contact information module 230 may obtain owner contact information associated with listings received by the query module 210 and not filtered out of the base set of listings by the selection module 220. In one embodiment, the contact information module 230 queries a commercial contact information service with the address of the property listing and receives owner contact information, such as a phone number, mobile phone number, or email address. The contact information module 230 may also search online databases of ownership records, such as property tax records or title records. In another embodiment, the contact information module 230 may generate an email or other communication to be sent to a researcher who searches paper-based files of ownership records, and receive owner contact information from the researcher. In one embodiment, phone numbers that are included within the contact information are marked as a “do not call number” when the particular phone number is registered within a “do not call” registry.

The mapping module 240 may map data fields from listings in the real estate listing server 110 database to the database format used by the lead generation server 140. When databases conforming to standard formats are used, the mapping module 240 may recognize and map corresponding fields according to the database standards. In other cases, the mapping module 240 may receive a specification prepared by a database analyst indicating how fields are to be mapped from one database to the other. Mapping data fields may also involve performing data conversions or transformations. For example, one database may have a single text field for a property address, and another database may have separate fields for the street address, city, state, and Zip Code. Migrating data from one database to the other would involve creating rules for parsing the address field of the first database and mapping the resulting data to data fields in the second database. Different databases may also employ different character encoding systems or image formats.

The database adapter 250 migrates listing records remaining in the base set of listings after filtering by the selection module 220, according to data field mappings specified by the mapping module 240.

The user interface module 260 may receive query parameters from the user to be submitted to the lead generation server 140 by the server communication module 270, which then may receive property listings and the associated contact information from the lead generation server 140 to be displayed to the user by the user interface module 260. In one embodiment, the user interface module 260 includes user interface controls that permit the user to view a list of property addresses, select an address to view additional data fields included in the listing, and obtain contact information for the property owner.

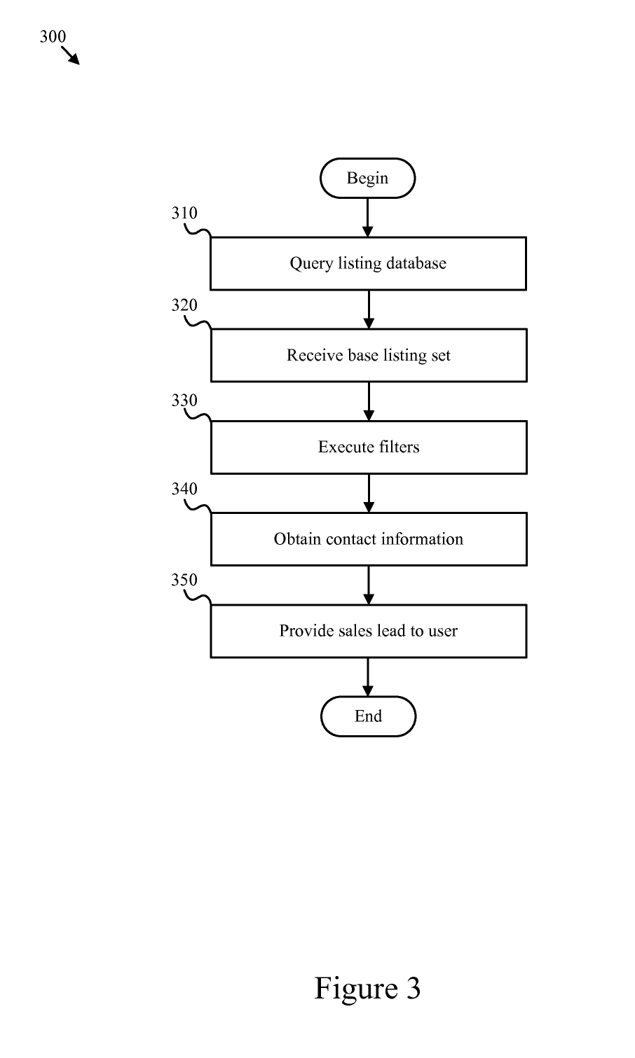

FIG. 3 is a flowchart diagram of one example of a sales lead generation method 300 that is consistent with one or more embodiments of the claimed invention. As depicted, the sales lead generation method 300 may include querying (310) a listing database, receiving (320) a base listing set, executing (330) filters, obtaining (340) contact information, and providing (350) sales leads. The sales lead generation method 300 may be used in conjunction with the sales lead generation server 140 to provide sales leads to a user utilizing a lead generation client 150.

Querying (310) a listing database may be performed by the query module 210 depicted in FIG. 2, and may include querying one or more real estate listing servers 110. Querying may include transmitting parameters to specify listings to be retrieved from the listing server 110. Query parameters may include starting and ending dates for the time period for which listings are to be retrieved, one or more geographical region identifiers, such as zip codes, a listing price range, a property type, such as a single family home, condominium, or commercial property, or the like.

Receiving (320) a base listing set may include receiving listings resulting from querying (310) a listing server 110. Receiving a base listing set may be performed by the query module 210 depicted in FIG. 2. In one embodiment, receiving a base listing set includes migrating received listings into a database local to the lead generation server 140.

Executing (330) filters may include deleting listings from the base listing set that meet specified criteria, such as properties currently listed for sale, that have sold since the listing date, that have been foreclosed since the listing date, that have been part of a short sale since the listing date, or the like. In one embodiment, executing filters includes modifying queries made to a real estate listing server 110 such that listings meeting the specified criteria are not received from the listing server 110.

Obtaining (340) contact information may include querying a database of contact information, such as an Internet phone number data service, property tax or property ownership records accessible via the Internet, a commercial contact information service, or the like for contact information corresponding to a real estate listing received from the real estate listing server 110. Obtaining contact information may also include searching paper-based records, such as property tax or property ownership records, or the like. In one embodiment, obtaining (340) contact information includes determining whether phone numbers that are included within the contact information are registered within a “do not call” registry and marking such numbers with a “do not call” flag.

Specific examples of contact information include a home phone number, a business phone number, one or more mobile phone numbers, a home address, a business address, a home email address, a work email address, a fax phone number, a social media identifier for a social media network such as LinkedIn™, Facebook™, Twitter™, and Google Plus™, a next of kin phone number, an absentee owner phone number, an absentee owner cell phone number, an absentee owner address, and owner name, a tenant name, a tenant home phone number, a tenant cell phone number, a spouse name, and property tax information

Providing (350) sales leads may include providing a database of real estate listings that may be queried by real estate lead generation clients 150. In one embodiment, providing sales leads includes providing a SQL database of real estate listings. In another embodiment, providing sales leads includes providing a web server that provides web browser clients with a form that a client may use to submit data fields on which database queries may be based. In another embodiment a web server provides a browser-based application that receives parameters entered by a user for querying a listing database.

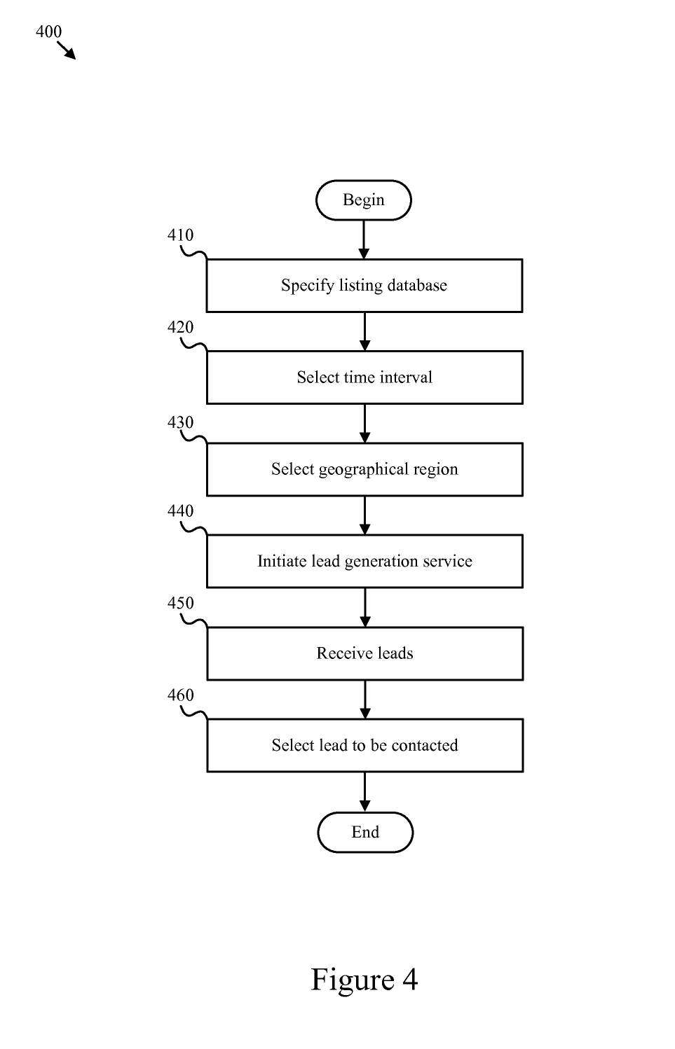

FIG. 4 is a flowchart diagram of one example of a sales lead selection method 400 that is consistent with one or more embodiments of the claimed invention. As depicted in FIG. 4, the sales lead selection method 400 may include specifying (410) a listing database, selecting (420) a time interval, selecting (430) a geographical region, initiating (440) a lead generation service, receiving (450) leads, and selecting (460) a lead to be contacted. The sales lead selection method 400 may be performed by the lead generation client 150, in conjunction with the sales lead generation method 300 depicted in FIG. 3, which may be performed by the lead generation server 140. The sales lead generation method 300 and the sales lead selection method 400 may be employed together to provide sales leads to a user.

Specifying (410) a listing database may include obtaining a network location for a database of real estate listings from a user. Specifying a listing database may also include obtaining authentication credentials for the database. In one embodiment, a web page includes a form or web application that obtains a URL, user ID, and password for a listing database from a user of the lead generation client 150. The specification for a listing database may also be a database server hostname, database name, and authentication credentials. In another embodiment, the location and authentication credentials are accessible to the lead generation server 140, for example, in a file or the like.

The lead generation client may display user interface elements to receive from a user various parameters to be used when querying a real estate listing server 110, or a database local to the lead generation server 140. Displaying user interface elements such as a form on a web page or a web application may facilitate selecting (420) a time interval and selecting (430) a geographical region. Selecting a time interval may include entering begin and end dates for a time interval for which to search for real estate listings. Selecting a geographical region may include entering a city or county name, Zip Code, or the like. Other parameters that may be specified include property type, such as single family home, condominium, undeveloped land, or commercial property; listing price range, foreclosure status, short sale status, or the like.

Initiating (440) a lead generation service may include sending query parameters from a lead generation client 150 to a lead generation server 140. In one embodiment, initiating a lead generation service includes providing a user interface element, such as a button on a web form or web application, a keyboard key, or the like that may be activated by the user.

Receiving (450) leads may include receiving real estate listings and associated contact information for display to a user on a lead generation client 150. Leads may be formatted as web pages, as data to be displayed in a web form, web application, or the like. In one embodiment, a summary of leads are displayed in a scrolling list control that allows a user to select a lead summary to be displayed in detail. In another embodiment, leads are displayed on separate pages, and the user permitted to page forward or backward from one lead listing page to the next.

Selecting (460) a lead to be contacted may include activating a user interface element to indicate that a lead is to be contacted. For example, a user interface element such as a button on a web page, a checkbox, or radio button, or the like, may be provided that, when initiated by the user, dials the phone number of a property owner.

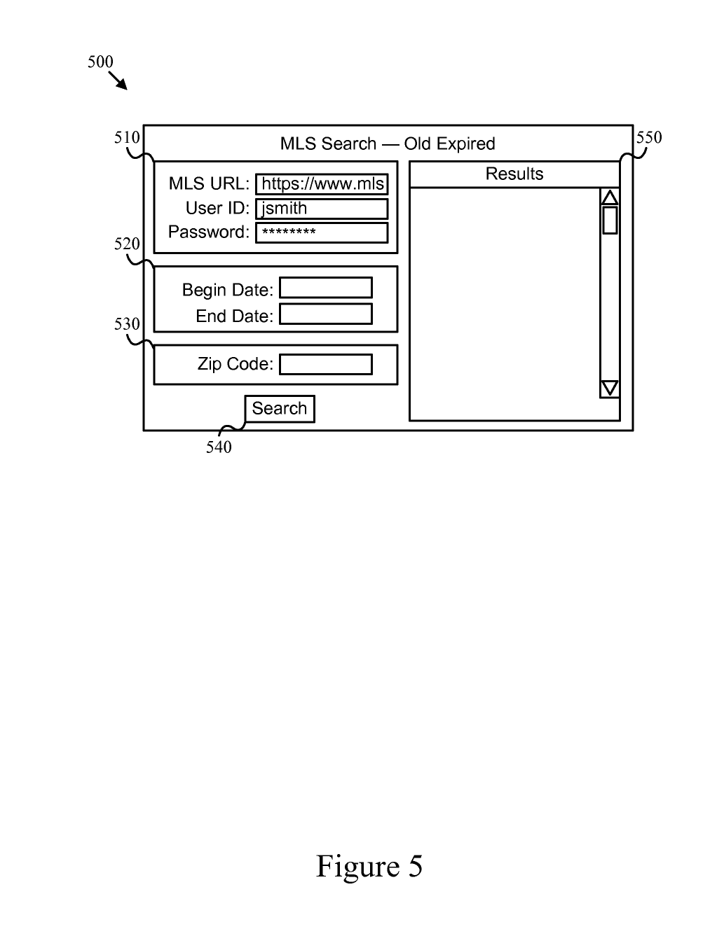

FIG. 5 is a graphical and textual depiction of one example of a sales lead selection user interface 500 that is consistent with one or more embodiments of the claimed invention. The sales lead selection user interface 500, as depicted, may include a listing database selector 510, a date range selector 520, a geographical region selector 530, a search initiator 540, and a search results selector 550. The sales lead selection user interface facilitates the entry of listing database query parameters and the display of sales leads. The sales lead selection user interface 500 may be used in conjunction with the sales lead selection method 400 displayed in FIG. 4.

The listing database selector 510 may include a user interface element for specifying the real estate listing database to be searched, along with authentication credentials for the database. In the embodiment depicted in FIG. 5, the listing database selector 510 includes text fields in which a user may enter the URL of a real estate listing server 110, a user ID, and password. In another embodiment, the listing database selector 510 includes a user interface element, such as a drop-down menu, scrolling list control, or the like, from which a user may select one or more databases known to the lead generation server 140 to be searched. In another embodiment, the listing database selector 510 is not present, and the lead generation server 140 searches a local database or one or more real estate listing servers 110 for which network locations and authentication credentials are available to the lead generation server 140.

The sales lead selection user interface 500 may include user interface elements in which the user may specify various parameters to be used when querying a listing database such as a real estate listing server 110 or a database local to the lead generation server 140. The sales lead selection user interface depicted in FIG. 5 includes a date range selector 520 that includes text fields in which the user may enter begin and end dates for the date range to be searched, and a geographical region selector 530 that includes a text field in which the user may enter a Zip Code specifying the geographical region to be searched. Other embodiments may include different control styles, such as drop-down menus, check boxes, list boxes, combo boxes, or the like; and additional user interface elements for specifying additional query parameters, such as a property type, such as single family home, condominium, undeveloped land, or commercial property; listing price range; foreclosure status; short sale status; or the like.

The search initiator 540 depicted in FIG. 5 includes a button the user may activate by clicking a mouse button to initiate a query of a listing database with specified query parameters. In another embodiment, a search initiator 540 is not included in the sales lead selection user interface 500, and the user initiates a query of a listing database by pressing the Enter key on a keyboard.

The search results selector 550 depicted in FIG. 5 includes a scrolling list in which brief descriptions of sales leads may be displayed after they are received from the lead generation server 140. The user may then select a sales lead to be viewed in detail by double-clicking a mouse button on one of the displayed sales leads. A detailed display of the selected sales lead may then be displayed in a pop-up window or a separate web page in a browser. In another embodiment, the search results selector 550 includes a single web page containing all sales leads resulting from a query of a listing database, through which a user may view by scrolling the page. The search results selector 550 may also include a user interface element, such as a button, radio button, check box, or the like, that a user may activate to initiate contact with one or more property owners associated with sales leads.

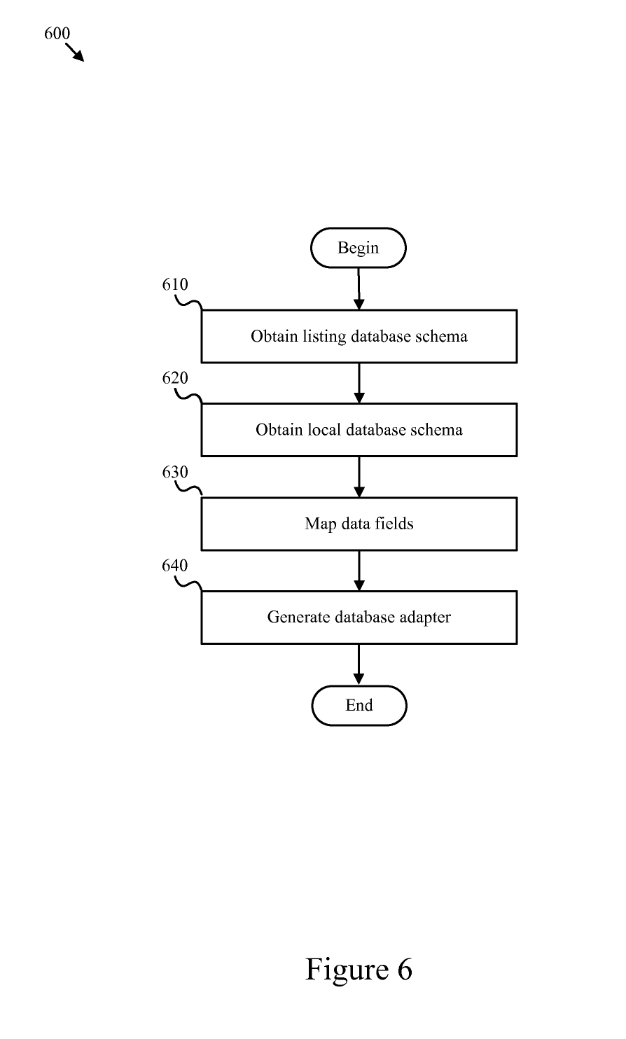

FIG. 6 is a flowchart diagram of one example of a sales data migration method 600 that is consistent with one or more embodiments of the claimed invention. As depicted, the sales data migration method 600 may include obtaining (610) a listing database schema, obtaining (620) a local database schema, mapping (630) data fields, and generating (640) a database adapter. The sales lead migration method 600 facilitates migrating real estate listings from a database associated with a real estate listing server 110 to a database local to a lead generation server 140.

Obtaining (610) a listing database schema and obtaining (620) a local database schema may include requesting documentation for a listing database from database administrators, obtaining access to the catalog, data dictionary, or published metadata for the listing database, querying a database to verify that tables and data fields conforming to a standard database schema are present, or reconstructing a database schema by enumerating data fields included in listings retrieved by database queries.

Mapping (630) data fields may include matching data fields in a listing database schema and local database schema by name and data type, using data-driven or semantic data mapping tools to discover mappings between data sets, and specifying data conversions or transformations required to map fields of a listing database to a local database. Data transformations may be required in such cases as when a source database uses 0 and 1 to represent False and True, and a destination database stores “No” and “Yes” strings in a corresponding field.

Depending upon how extensive the required data transformations may be, generating (640) a database adapter may include developing database queries to select data to be migrated to the destination database, generating a transformation program from a formal transformational language specification, or developing custom code to implement data migration according to a schema map. Where both the source and destination databases comply with the Real Estate Transaction Standard (RETS), generating a database adapter may include developing the RETS client queries to retrieve listings including the desired data.

The various elements of the sales lead generation system function cooperatively to facilitate productive real estate sales lead generation. The preceding depiction of the sales lead generation system and other inventive elements described herein are intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating sales leads for real estate, the method comprising:
mapping data fields between a remote database of real estate listings and a local database of real estate listings;
querying the remote database of real estate listings for listings within a selected time interval and geographical region;
receiving in response to the query, a base set of listings for the selected time interval and geographic region, each listing of the base set of listings comprising a listing date;
executing one or more filters that remove from the base set of listings, listings that correspond to a change in ownership or a current offer for sale;
adding records from the base set of listings into the local database of real estate listings, according to the mapping of data fields between the remote database of real estate listings and the local database of real estate listings;

2. The method of claim 1, further comprising obtaining contact information for at least one listing remaining in the base set of listings.

3. The method of claim 1, wherein a filter of the one or more filters removes listings corresponding to criteria selected from the group consisting of properties that have sold since the listing date, properties that are currently listed for sale, properties that have been foreclosed since the listing date, and properties that have been part of a short sale since the listing date.

4. The method of claim 3, further comprising providing a user interface that enables a user to specify the selected time interval and geographical region.

5. The method of claim 1, wherein a decrease in the rate of real estate sales occurred in the selected time interval in the selected geographical region.

6. The method of claim 1, wherein querying a database of real estate listings comprises querying a listing service database.

7. The method of claim 1, wherein the listing date is selected from the group consisting of a first listed date, a listing expiration date, a contract date, and a listing queried date.

8. The method of claim 1, wherein obtaining contact information comprises querying a contact information source selected from the group consisting of an online database, a proprietary database, property tax records, and property title records.

9. The method of claim 8, wherein the contact information is selected from the group consisting of a home phone number, a business phone number, one or more mobile phone numbers, a home address, a business address, a home email address, a work email address, a fax phone number, a social media identifier, a next of kin phone number, an absentee owner phone number, an absentee owner cell phone number, an absentee owner address, and owner name, a tenant name, a tenant home phone number, a tenant cell phone number, a spouse name, and property tax information.

10. An apparatus for generating sales leads for real estate, the apparatus comprising:
a mapping module configure to map data fields between a remote database of real estate listings and a local database of real estate listings;
a query module configured to query the remote database of real estate listings for listings within a selected time interval and geographical region;
the query module further configured to receive, in response to the query, a base set of listings for the selected time interval and geographic region, each listing of the base set of listings comprising a listing date;
a selection module configured to execute one or more filters that remove from the base set of listings, listings that correspond to a change in ownership or a current offer for sale; and
a database adapter configured to add records from the base set of listings into the local database of real estate listings, according to the mapping of data fields between the database of real estate listings and the local database of real estate listings.

11. The apparatus of claim 10, further comprising a contact information module configured to obtain contact information for at least one listing remaining in the base set of listings.

12. The apparatus of claim 10, wherein a filter of the one or more filters removes listings corresponding to criteria selected from group consisting of properties that have sold since the listing date, properties that are currently listed for sale, properties that have been foreclosed since the listing date, and properties that have been part of a short sale since the listing date.

13. The apparatus of claim 10, further comprising an interface element configured to query the local database of real estate listings, receive in response to the query at least one property owner, and enable a user to select at least one property owner to be contacted via the contact information.

14. The apparatus of claim 10, wherein the query module is further configured to query a listing service database.

15. The apparatus of claim 10, wherein the listing date is selected from the group consisting of a first listed date, a listing expiration date, a contract date, and a listing queried date.

16. The apparatus of claim 10, wherein the contact information associated with each listing is obtained from sources selected from the group consisting of online databases, proprietary databases, property tax records, and property title records.

17. The apparatus of claim 16, wherein the contact information is selected from the group consisting of a home phone number, a business phone number, one or more mobile phone numbers, a home address, a business address, a home email address, a work email address, a fax phone number, a social media identifier, a next of kin phone number, an absentee owner phone number, an absentee owner cell phone number, an absentee owner address, and owner name, a tenant name, a tenant home phone number, a tenant cell phone number, a spouse name, and property tax information.

18. A system for generating sales leads for real estate, the system comprising:
a real estate listing server comprising a remote database of real estate listings;
a lead generation server configured to query the real estate listing server for listings within a selected time interval and geographical region;
the lead generation server configured to receive, in response to the query, a base set of listings for the selected time interval and geographic region, each listing of the base set of listings comprising a listing date;
the lead generation server configured to execute one or more filters that remove from the base set of listings, listings that correspond to a change in ownership or a current offer for sale;
the lead generation server configured to map data fields between the remote database of real estate listings and a local database of real estate listings;
the lead generation server configured to add records from the base set of listings into the local database of real estate listings, according to the mapping of data fields between the remote database of real estate listings and the local database of real estate listings.

19. The system of claim 18, wherein a filter of the one or more filters removes listings corresponding to criteria selected from group consisting of properties that have sold since the listing date, properties that are currently listed for sale, properties that have been foreclosed since the listing date, and properties that have been part of a short sale since the listing date.

20. The system of claim 18, wherein the lead generation server is configured to obtain contact information associated with each listing remaining in the base set of listings from a contact information server, wherein the contact information is selected from the group consisting of a home phone number, a business phone number, one or more mobile phone numbers, a home address, a business address, a home email address, a work email address, a fax phone number, a social media identifier, a next of kin phone number, an absentee owner phone number, an absentee owner cell phone number, an absentee owner address, and owner name, a tenant name, a tenant home phone number, a tenant cell phone number, a spouse name, and property tax information.
